(19) United States
(12) Patent Application Publication
(10) Pub. No.: US 2026/0298836 A1
(43) Pub. Date: Oct. 1, 2026

(54) INSPECTION APPARATUS, INSPECTION METHOD USING THE INSPECTION APPARATUS, AND ELECTRONIC DEVICE INSPECTED BY THE INSPECTION APPARATUS

(71) Applicant: Samsung Display Co., LTD., Yongin-si, Gyeonggi-do (KR)

(72) Inventors: HYUNGKEUN PARK, Yongin-si (KR); MIN-KYU YEO, Yongin-si (KR); JURI NAM, Yongin-si (KR); HYUNDO SHIN, Yongin-si (KR); BYUNG-SU OH, Yongin-si (KR)

(21) Appl. No.: 19/364,024

(22) Filed: Oct. 21, 2025

(30) Foreign Application Priority Data
Mar. 27, 2025 (KR) 10-2025-0039188

(51) Int. Cl. G01N 21/88; G01N 21/956

(52) U.S. Cl. CPC G01N 21/8851; G01N 21/956; G01N 2021/8861

(57) ABSTRACT

An inspection method includes: generating a virtual image of a cell based on a design drawing of the cell; defining a reference coordinate to be inspected in the virtual image of the cell; defining an interference area in which a capture area of a capture part and a frame overlap each other, where the capture part captures the cell, and the frame supports the cell; identifying an interference coordinate overlapping the interference area in a plan view among the reference coordinate; and setting an alternative coordinate which is adjacent to the interference coordinate in the cell, has a laminated structure identical to a laminated structure of the interference coordinate, and is spaced apart from the interference area in the plan view.

### CROSS-REFERENCE TO RELATED APPLICATION

This application claims priority to Korean Patent Application No. 10-2025-0039188, filed on Mar. 27, 2025, and all the benefits accruing therefrom under 35 U.S.C. §119, the content of which in its entirety is herein incorporated by reference.

### BACKGROUND

### 1. Field

The present disclosure relates generally to an inspection apparatus, an inspection method using the inspection apparatus, and an electronic device inspected by the inspection apparatus. More particularly, the present disclosure relates to an inspection apparatus that reduces process time, an inspection method using the inspection apparatus, and an electronic device inspected by the inspection apparatus.

### 2. Description of the Related Art

With the rapid spread of information media such as a computer, an electronic device or a semiconductor device are also rapidly developing. A manufacturing technology of the electronic device and/or the semiconductor device is being developed to improve integration, reliability, response speed, or the like.

Accordingly, as part of strengthening competitiveness in the semiconductor industry, each unit process that can ensure high production yields is being developed, and at the same time, a method and an apparatus for inspecting process errors in each unit process are being actively researched.

### SUMMARY

Embodiments provide an inspection method with reduced process time.

Embodiments provide an inspection apparatus utilizing the inspection method.

Embodiments provide an electronic device manufactured by the inspection method.

An inspection method according to an embodiment of the present disclosure includes: generating a virtual image of a cell based on a design drawing of the cell; defining a reference coordinate to be inspected in the virtual image of the cell; defining an interference area in which a capture area of a capture part and a frame overlap each other, where the capture part captures the cell, and the frame supports the cell; identifying an interference coordinate overlapping the interference area in a plan view among the reference coordinate; and setting an alternative coordinate which is adjacent to the interference coordinate in the cell, has a laminated structure identical to a laminated structure of the interference coordinate, and is spaced apart from the interference area in the plan view.

In an embodiment, in the defining the reference coordinate, the reference coordinate may correspond to one of a line width of a metal line and a position of a hole included in the cell.

In an embodiment, the defining the interference area may include obtaining a plurality of frame coordinates corresponding to the frame and serializing the plurality of frame coordinates.

In an embodiment, in the setting the alternative coordinate, a separation distance between the interference coordinate and the alternative coordinate may be within about 2 mm.

In an embodiment, the inspection method may further include comparing a planar shape of the cell at a measurement coordinate, which is a coordinate spaced apart from the interference area among the reference coordinate, and the alternative coordinate with the virtual image of the cell at the measurement coordinate and the alternative coordinate after the setting the alternative coordinate.

In an embodiment, the comparing the planar shape of the cell with the virtual image of the cell may include checking whether a matching degree between a pattern of the planar shape of the cell and a pattern of the virtual image of the cell is greater than a threshold value.

In an embodiment, the threshold value may be greater than or equal to about 0.85.

In an embodiment, the inspection method may further include measuring at the measurement coordinate and the alternative coordinate of the cell when the matching degree of the pattern is greater than the threshold value.

In an embodiment, the inspection method may further include redesigning a process for the cell when the matching degree of the pattern is less than or equal to the threshold value.

In an embodiment, the redesigning the process for the cell may be performed within about 7 days.

In an embodiment, the generating the virtual image of the cell to the redesigning the process for the cell may be performed within about 40 days.

In an embodiment, the process for the cell may include one of an etching process and a cleaning process.

An inspection apparatus according to an embodiment of the present disclosure includes: a virtual image generator which generates a virtual image of a cell based on a design drawing of the cell, wherein the cell is loaded on a frame; a reference coordinate determination part which defines a reference coordinate to be inspected in the virtual image of the cell; a cell capture part which captures the cell disposed on the frame and defines an interference area overlapping the frame; and a measurement part which measures an image of the cell captured by the cell capture part.

In an embodiment, the reference coordinate determination part may define an alternative coordinate adjacent to an interference coordinate which overlaps the interference area defined by the cell capture part in a plan view.

In an embodiment, a separation distance between the interference coordinate and the alternative coordinate may be within about 2 mm.

In an embodiment, the frame may have a mesh shape in a plan view.

In an embodiment, the frame may include a first frame and a second frame. In such an embodiment, the first frame may define a first interference area, and the second frame may define a second interference area. In such an embodiment, the interference area may be an area where the first interference area and the second interference area overlap each other.

In an embodiment, the reference coordinate may correspond to one of a metal and a hole included in the cell.

In an embodiment, the measurement part may measure one of a line width of a metal line and a position of a hole defined by the reference coordinate.

An electronic device according to an embodiment of the present disclosure includes: a display device; and a processor which drives the display device. In such an embodiment, the display device is manufactured by an inspection method, and the inspection method includes: generating a virtual image of a cell based on a design drawing of the cell; defining a reference coordinate to be inspected in the virtual image of the cell; defining an interference area in which a capture area of a capture part and a frame overlap each other, where the capture part captures the cell, and the frame supports the cell; identifying an interference coordinate overlapping the interference area in a plan view among the reference coordinate; and setting an alternative coordinate which is adjacent to the interference coordinate in the cell, has a laminated structure identical to a laminated structure of the interference coordinate, and is spaced apart from the interference area in the plan view.

In embodiments of the present disclosure, the inspection method may identify the interference coordinate overlapping the interference area, which is defined by the frame, in a plan view among the reference coordinate before measurement. In such embodiments, the interference coordinate may be replaced with the alternative coordinate before being measured by a measurement part. Accordingly, by excluding the interference coordinate that is not measured by the measurement part in advance before measurement, the process correction time after measurement may be shortened. As a result, by defining the alternative coordinate before measurement, the overall production efficiency of the process may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an inspection apparatus according to an embodiment of the present disclosure.

FIG. 2 is a flow chart illustrating an inspection method according to an embodiment of the present disclosure.

FIG. 3 is a flow chart illustrating an embodiment of a method of defining an interference area of FIG. 2.

FIG. 4 is a plan view illustrating an embodiment of a mother substrate including a cell described in FIG. 2.

FIG. 5 is a plan view illustrating the mother substrate of FIG. 4 disposed on a frame.

FIG. 6 is a plan view illustrating frame coordinates of the frame supporting the cell illustrated in FIG. 5.

FIG. 7 is a plan view illustrating an interference coordinate defined by continuing the frame coordinates of FIG. 6.

FIG. 8 is a plan view illustrating a process of defining a reference coordinate in the cell illustrated in FIG. 7.

FIG. 9 is a plan view illustrating a process of replacing an interference coordinate overlapping the frame among a reference coordinate of FIG. 8 with an alternative coordinate.

FIG. 10 is a plan view illustrating a measurement process at the coordinates defined in FIG. 9.

FIG. 11 is a block diagram illustrating an electronic device according to an embodiment of the present disclosure.

FIG. 12 is a schematic view of an electronic device of FIG. 11 according to various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be understood that when an element is referred to as being “connected” or “coupled” to another element, it may be directly connected or coupled to the other element or intervening element(s) may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for a purpose of describing particular example embodiments only and is not intended to be limiting of the present inventive concept. As used herein, the singular forms “a,” “an” and “the” are intended to include plural forms as well, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify a presence of stated features, integers, steps, operations, elements, and/or components, but do not preclude the presence or addition of one or more other features, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

"About" or "approximately" as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, "about" can mean within one or more standard deviations, or within ± 30%, 20%, 10% or 5% of the stated value.

Unless otherwise defined, all terms (including technical and scientific terms) used herein have a same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in detail with reference to the accompanying drawings. The same reference numerals are used for the same components in the drawings, and any repetitive detailed descriptions of the same components will be omitted or simplified.

In this specification, a plane may be defined by a first direction D1 and a second direction D2 intersecting the first direction D1. For example, the second direction D2 may be perpendicular to the first direction D1. In addition, a third direction D3 may be a normal direction of the plane. That is, the third direction D3 may be perpendicular to the plane defined by the first direction D1 and the second direction D2.

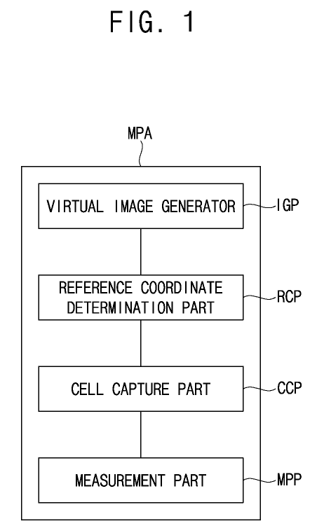

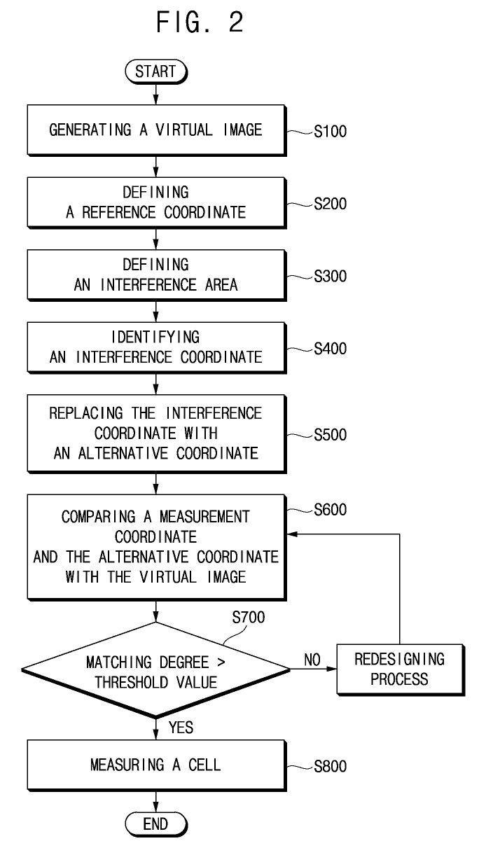

FIG. 1 is a block diagram illustrating an inspection apparatus according to an embodiment of the present disclosure. FIG. 2 is a flow chart illustrating an inspection method according to an embodiment of the present disclosure.

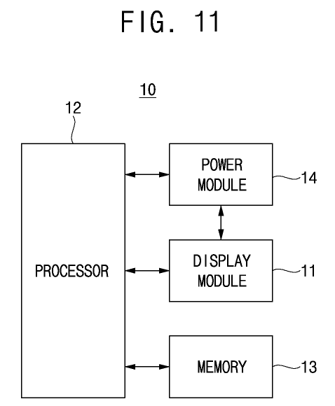

Referring to FIGS. 1 and 2, an embodiment of an inspection apparatus MPA may predict a patterning result during a manufacturing process of an electronic device (e.g., an electronic device 10 of FIG. 11), a semiconductor device, or a battery. In an embodiment, for example, the electronic device 10 or the semiconductor device may include a mobile phone, a smart phone, a tablet personal computer (PC), a mobile communication terminal, an electronic notebook, an electronic book, a portable multimedia player (PMP), a navigation device, or an ultra mobile PC (UMPC). In another embodiment, for example, the electronic device 10 or the semiconductor device may be a television, a laptop computer, a monitor, a billboard, or a display part of an Internet Of Things (IOT). In another embodiment, for example, the electronic apparatus 10 or the semiconductor device may include a wearable device, such as a smart watch, a watch phone, a glasses-type display, and a head mounted display (HMD).

An embodiment of the inspection apparatus MPA may include a virtual image generator IGP, a reference coordinate determination part RCP, a cell capture part CCP, and a measurement part MPP. In an embodiment, each of the virtual image generator IGP, the reference coordinate determination part RCP, the cell capture part CCP, and the measurement part MPP may include or be defined by a circuitry which performs instructions corresponding to operations thereof described herein.

The virtual image generator IGP may generate a virtual image based on at least one layer illustrated in a design drawing. The design drawing may include a layout drawing of each of a plurality of layers, and the virtual image generator IGP may generate the virtual image in an order in which the plurality of layers are sequentially stacked. In this case, the plurality of layers may include at least one metal layer and at least one organic layer.

In an embodiment, the virtual image generator IGP may generate a virtual image including a first layer, a virtual image including first and second layers, and a virtual image including first to third layers (S100). Accordingly, the virtual image generator IGP may generate a virtual image based on a design drawing of the semiconductor device or the like. However, the embodiments of the present disclosure are not necessarily limited thereto.

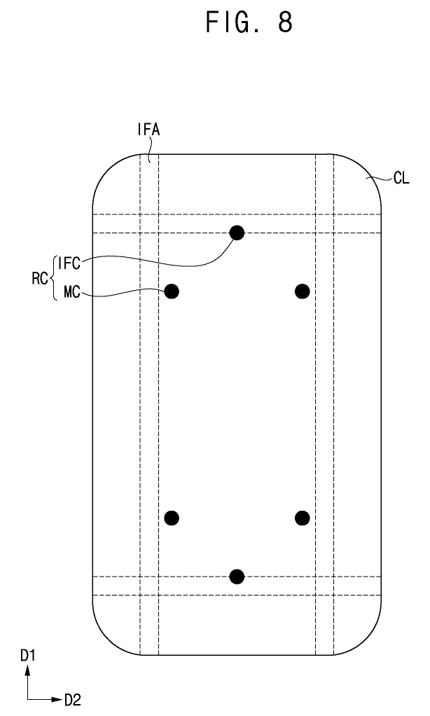

The reference coordinate determination part RCP may define a reference coordinate (RC, see FIG. 8) to be inspected (or measured) in the virtual image (S200). The reference coordinate determination part RCP may receive a plurality of virtual images from the virtual image generator IGP, and may determine the reference coordinate RC for each of the plurality of virtual images.

In an embodiment, the reference coordinate determination part RCP may determine a plurality of the reference coordinates RC per one virtual image. In an embodiment, for example, the reference coordinate determination part RCP may determine the reference coordinate RC by receiving a user’s input, but the present disclosure is not necessarily limited thereto. The reference coordinate RC may include at least one area defined by at least one metal line, at least one hole, or a layer.

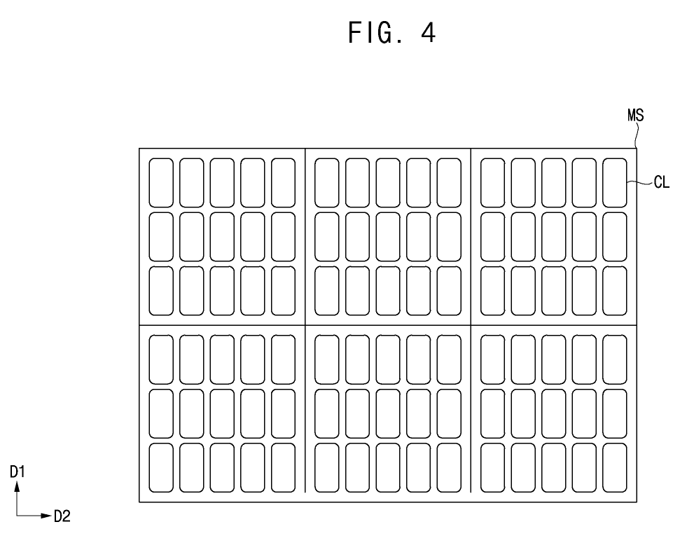

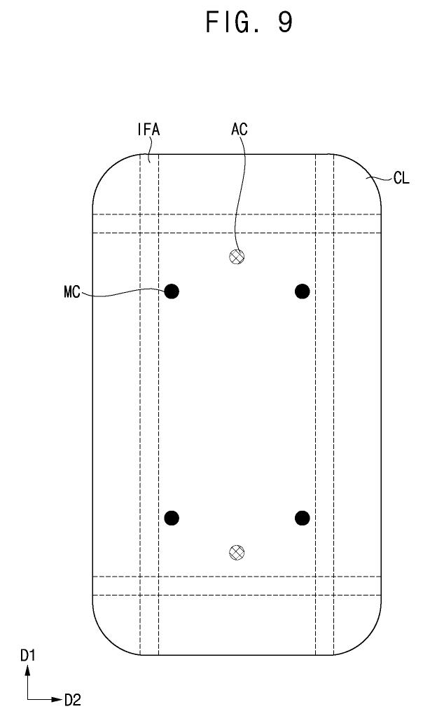

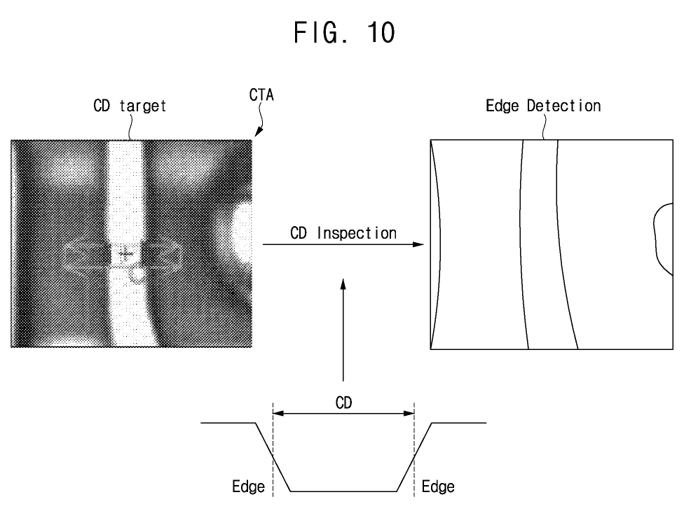

The cell capture part CCP may capture a cell (CL, see FIGS. 4 or 9) to be an inspection target. In an embodiment, the cell capture part CCP may further include an optical device (e.g., a camera) for capturing a real image of the cell to be the inspection target. In an embodiment, the cell capture part CCP may receive a captured image of the cell from an outside or an external device. The cell capture part CCP may perform pattern matching of an inspection target based on a capture area (CTA, see FIG. 10) (S600) and may confirm whether a real image and a virtual image of the inspection target satisfy a preset level of matching (S700).

The measurement part MPP may perform measurement of the capture area CTA based on the reference coordinate RC (S800). The measurement part MPP may measure a size of a line width, a position of a hole, and a shape and a size of an area of the capture area CTA. The measurement part MPP may serve to measure a critical dimension based on the reference coordinate RC.

In an embodiment, for example, the measurement part MPP may serve to perform a line width, a hole, or an area measurement of the capture area CTA by performing at least one pattern measurement of overlay, refractive index, and thickness based on the reference coordinate RC. By performing the pattern measurement of the overlay, the measurement part MPP may measure the misalignment of lines.

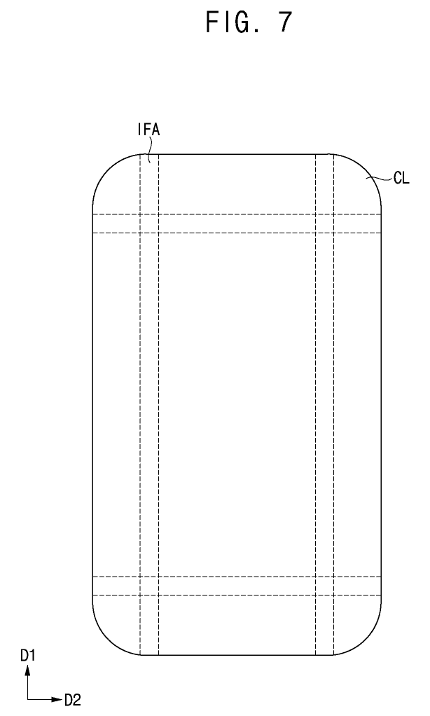

The process of defining an interference area (IFA, see FIG. 7) (S300) to the process of replacing an interference coordinate (IFC, see FIG. 8) with an alternative coordinate (AC, see FIG. 9) (S500) illustrated in FIG. 2 will be described below with reference to FIGS. 4 to 9.

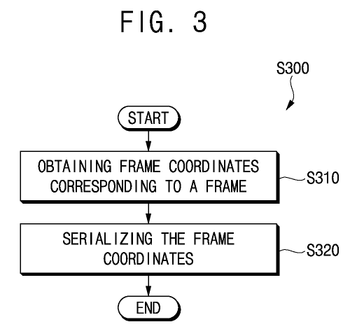

FIG. 3 is a flow chart illustrating an embodiment of a method of defining an interference area of FIG. 2.

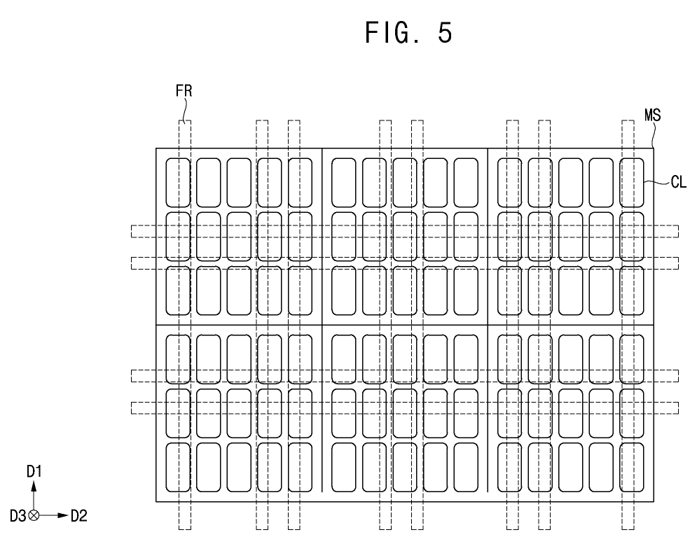

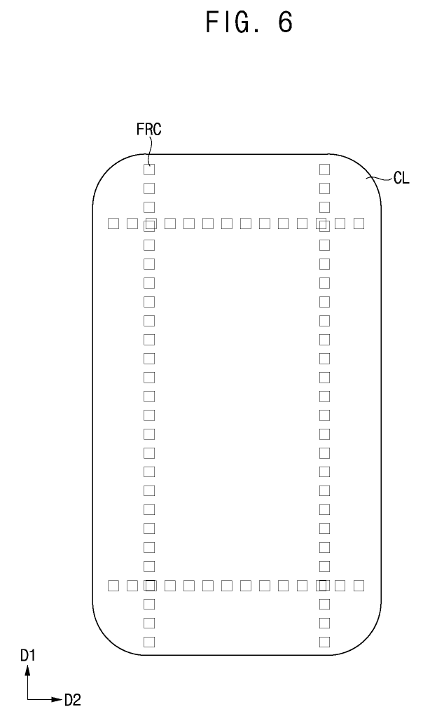

Referring to FIGS. 1, 2, and 3, in an embodiment of a method of defining an interference area, the cell capture part CCP may obtain frame coordinates (FRL, see FIG. 6) of a frame (FR, see FIG. 5) overlapping the cell CL in a plan view (S310). Thereafter, the cell capture part CCP may define the interference area IFA having a linear shape in a plan view by continuing the frame coordinates FRL (S320). The defining the interference area IFA by the cell capture part CCP will be described below with reference to FIGS. 6 and 7.

FIG. 4 is a plan view illustrating an embodiment of a mother substrate included in a cell described in FIG. 2.

Referring to FIGS. 2 and 4, an embodiment of a mother substrate MS may include a plurality of the cells CL. The cells CL may be arranged along the first direction D1 and/or the second direction D2 on the mother substrate MS. Each of the cells CL may include a substrate or the like that is included in a display device.

In an embodiment, as shown in FIG. 4, the mother substrate MS and the cells CL may have a rectangular shape, but embodiments of the present disclosure are not necessarily limited thereto. In another embodiment, the mother substrate MS may have one of other various shapes such as circular, oval, polygonal, or the like in a plan view.

In an embodiment, each of the cells CL may include a plurality of layers, and the plurality of layers may include at least one metal layer and at least one organic layer. In addition, the plurality of layers of each of the cells CL may include at least one metal line, at least one hole, or at least one area defined by the layer. That is, each of the cells CL may be a display panel included in a display device. However, embodiments of the present disclosure are not necessarily limited thereto.

FIG. 5 is a plan view illustrating the mother substrate of FIG. 4 disposed on a frame.

Referring to FIGS. 2, 4, and 5, in an embodiment, a frame FR may be disposed under the mother substrate MS. In an embodiment, for example, the frame FR may be disposed in the third direction D3 from the mother substrate MS. Accordingly, the frame FR may support the mother substrate MS.

In an embodiment, the frame FR may extend in the first direction D1 and the second direction D2. That is, the frame FR may have a mesh shape in a plan view. In an embodiment, as shown in FIG. 5, the frame FR may include eight supports extending in the first direction D1 and four supports extending in the second direction D2, but embodiments of the present disclosure are not necessarily limited thereto. The planar shape and number of the frame FR may vary according to embodiments.

In an embodiment, the frame FR may include a metal or the like. In an embodiment, for example, the frame FR may include aluminum (Al), copper (Cu), or the like. When the cell capture part (CCP, see FIG. 1) captures the cell CL, as the frame FR includes metal, the cell CL may not be accurately captured in an area overlapping the frame FR. To solve this problem or to accurately capture the cell CL in an area overlapping the frame FR, it is desired to capture an image except for a portion of the cell CL overlapping the frame FR in a plan view.

FIG. 6 is a plan view illustrating frame coordinates of the frame supporting the cell illustrated in FIG. 5. FIG. 7 is a plan view illustrating an interference coordinate defined by continuing the frame coordinates of FIG. 6.

Referring to FIGS. 1, 2, 3, 4, 5, and 6, in an embodiment, the cell capture part CCP may capture the cell CL. The cell capture part CCP may obtain a frame coordinate FRC of the frame FR overlapping the cell CL in a plan view. The frame coordinate FRC may vary according to embodiments depending on the image quality, magnification, or the like of the cell capture part CCP. In an embodiment, for example, the cell capture part CCP may capture the cell CL at a magnification of about 70 times to about 100 times. However, embodiments of the present disclosure are not necessarily limited thereto.

Referring further to FIG. 7, the cell capture part CCP may serialize the frame coordinates FRC. In an embodiment, as illustrated in FIG. 7, the cell capture part CCP may define the interference area IFA by serializing (or continuing) the frame coordinates FRC (S300). In an embodiment, for example, the interference area IFA may refer to an area of the cell CL that overlaps the frame FR in a plan view and cannot be captured by the cell capture part CCP.

In an embodiment, the interference area IFA may be defined by a plurality of measurement parts. In an embodiment, for example, where the inspection apparatus MPA (illustrated in FIG. 1) includes a first inspection apparatus and a second inspection apparatus, the first inspection apparatus may include a first measurement part, and the second inspection apparatus may include a second measurement part. In such an embodiment, as described with reference to FIG. 7, the first measurement part may define a first interference area, and the second measurement part may define a second interference area. The inspection apparatus MPA may define an area where the first interference area and the second interference area overlap each other as the interference area IFA. As the interference area IFA is defined by a plurality of measurement parts, the interference area IFA that is not captured by the frame FR may be defined more precisely.

FIG. 8 is a plan view illustrating a process of defining a reference coordinate in the cell illustrated in FIG. 7. FIG. 9 is a plan view illustrating a process of replacing an interference coordinate overlapping the frame among a reference coordinate of FIG. 8 with an alternative coordinate.

Specifically, FIG. 8 is a plan view illustrating a process of defining a reference coordinate RC in the virtual image (S200) of FIG. 2. FIG. 9 is a plan view illustrating a process of replacing an interference coordinate IFC overlapping the frame FR among the reference coordinate RC with an alternative coordinate AC (S500) of FIG. 2.

Referring to FIGS. 1, 2, 7, 8, and 9, in an embodiment, the reference coordinate determination part RCP may define the reference coordinate RC that is a capture target in the cell CL (S200). The reference coordinate RC may include at least one area defined by at least one metal line, at least one hole, or a layer included in the cell CL. However, embodiments of the present disclosure are not necessarily limited thereto.

The reference coordinate RC may include the interference coordinate IFC that overlaps the interference area IFA and a measurement coordinate MC that does not overlap the interference area IFA in a plan view.

After defining the reference coordinate RC, the inspection apparatus MPA may identify the interference coordinate IFC overlapping the interference area IFA in a plan view among the reference coordinate RC (S400). Thereafter, the inspection apparatus MPA may replace the interference coordinate IFC with the alternative coordinate AC so that the cell capture part CCP may capture the alternative coordinate AC (S500). The alternative coordinate AC may have a same laminated structure as the interference coordinate IFC. In an embodiment, for example, when the interference coordinate IFC is an area having a hole area, the alternative coordinate AC may be defined as an area having a hole area.

In an embodiment, a separation distance between the interference coordinate IFC and the alternative coordinate AC may be within about 2 mm in a plan view. In an embodiment, for example, the separation distance between the interference coordinate IFC and the alternative coordinate AC may be within about 1 mm in a plan view. The component of the cell CL positioned at the alternative coordinate AC and the component of the cell CL positioned at the interference coordinate IFC may be manufactured by a same process during a manufacturing process. By satisfying the above-described range of the separation distance between the alternative coordinate AC and the interference coordinate IFC, a laminated structure at the alternative coordinate AC may be substantially the same as a laminated structure at the interference coordinate IFC. Therefore, even if the alternative coordinate AC is captured and measured, substantially identical data may be obtained as if the cell CL is measured at the interference coordinate IFC.

After defining the alternative coordinates AC, the cell CL may be captured at the measurement coordinate MC and the alternative coordinate AC through the cell capture part CCP, and it may be confirmed whether a real image and the virtual image match each other by comparing the virtual image and the captured image in a same area (S600).

In an embodiment, when a matching degree between the real image and the virtual image is greater than a threshold value, measurement may be performed by the measurement part MPP (S700). In an embodiment, for example, the threshold value may be greater than or equal to about 0.85. In an embodiment, for example, the threshold value may be greater than or equal to about 0.9.

In an embodiment, for example, when the matching degree between the real image and the virtual image is greater than the threshold value, measurement may be initiated at the measurement coordinate MC and the alternative coordinate AC of the cell CL. Measuring the cell CL will be described below with reference to FIG. 10.

In an embodiment, for example, when the matching degree between the real image and the virtual image is less than or equal to the threshold value, process redesign for the cell CL may be performed. The redesign of the process for the cell CL may be performed within about 7 days. In an embodiment, for example, the redesign of the process may be performed within about 6 days. The process for the cell CL may include one of an etching process or a cleaning process. However, embodiments of the present disclosure are not necessarily limited thereto.

If there is no process of replacing the interference coordinate IFC with the alternative coordinate AC, the process redesign may take about 7.5 days because the reference coordinate RC should be corrected in the redesign process. According to an embodiment of the present disclosure, by performing the process of replacing the interference coordinate IFC with the alternative coordinate AC (S500) before measuring the cell CL (S800), the period desired for the process redesign may be shortened. Accordingly, the process time for the cell CL may be shortened, thereby increasing the overall process efficiency.

FIG. 10 is a plan view illustrating a measurement process at the coordinates defined in FIG. 9.

Referring to FIG. 10, in an embodiment, the measurement part (MMP, see FIG. 1) may perform measurement of the capture area CTA based on the reference coordinate (RC, see FIG. 8) (S800). The measurement part MMP may measure the size of the line width, the position of the hole, and the shape and size of the area of the measurement point (CD Target in FIG. 10) of the capture area CTA. The measurement part MMP may perform critical dimension (CD in FIG. 10) inspection based on the measurement coordinate MC and the alternative coordinate AC. In an embodiment, for example, the measurement part MMP may detect an edge of the layers, and may perform the measurement based on the edge of the layers as the critical dimension inspection. In an embodiment, for example, the measurement part MMP may perform at least one pattern measurement of overlay, refractive index, and thickness based on the measurement coordinate MC and the alternative coordinate AC. By performing the pattern measurement of the overlay, the measurement part MMP may measure the misalignment of lines. Thus, the measurement part MMP may serve to measure a line width, a hole, an area, or the like of the measurement point (CD Target).

In an embodiment, processes from the generating the virtual image (S100) to the measuring the cell CL (S800) may be performed within about 40 days. In an embodiment, for example, processes from the generating the virtual image (S100) to the measuring the cell CL (S800) may be performed within about 38 days. In such an embodiment, by including the replacing the interference coordinate IFC with the alternative coordinate AC (S500) before the measuring the cell CL (S800), the process time for performing all processes may be shortened.

Accordingly, the inspection method may identify the interference coordinate IFC overlapping the interference area IFA, which is defined by the frame FR, in a plan view among the reference coordinate RC before measurement. The interference coordinate IFC may be replaced with the alternative coordinate AC before being measured by the measurement part MPP. Accordingly, by excluding the interference coordinate IFC that is not measured by the measurement part MPP in advance before measurement, the process correction time after measurement may be shortened. As a result, by defining the alternative coordinate AC before measurement, the overall production efficiency of the process may be improved.

FIG. 11 is a block diagram illustrating an electronic device according to an embodiment of the present disclosure.

Referring to FIG. 11, the inspection method according to embodiments may be applied to various electronic devices 10. The electronic device 10 according to an embodiment may include a display device, and the display device may include a display panel included in the cell (CL, see FIG. 4). In addition, the electronic device 10 may further include modules or devices having other additional functions in addition to the display device.

In an embodiment, the electronic device 10 may include a display module 11, a processor 12, a memory 13, and a power module 14. The display module 11 may correspond to the display panel described above.

The processor 12 may include at least one selected from a central processing unit (CPU), an application processor (AP), a graphic processing unit (GPU), a communication processor (CP), an image signal processor (ISP), and a controller.

The memory 13 may store data information used for operation of the processor 12 or the display module 11. When the processor 12 executes an application stored in the memory 13, an image data signal and/or an input control signal may be transmitted to the display module 11, and the display module 11 may process the received signals and may output image information through a display screen.

The power module 14 may include a power supply module, such as a power adapter or a battery device, etc., and a power conversion module that converts power supplied by the power supply module to generate the power used for operation of the electronic device 10.

At least one of the components of the electronic device 10 described above may be included in the display device. In addition, some of the individual modules that are functionally included in one module may be included in the display device and others may be provided separately from the display device. In an embodiment, for example, the display device may include the display module 11, and the processor 12, the memory 13, and the power module 14 may be provided in the form of other devices in the electronic device 10 other than the display device.

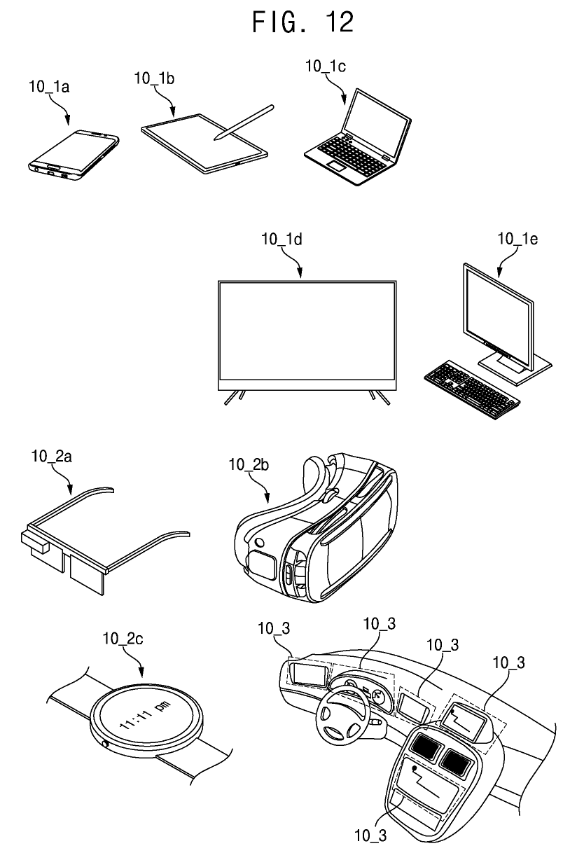

FIG. 12 is a schematic view of an electronic device of FIG. 11 according to various embodiments.

Referring to FIGS. 11 and 12, various embodiments of an electronic device to which the display device is applied may include image display electronic devices such as a smartphones 10_1a, a tablet personal computer (PC) 10_1b, a laptop computer 10_1c, a television 10_1d, a desk monitor 10_1e, or the like, wearable electronic devices including display modules such as a smart glasses 10_2a, a head-mounted display 10_2b, and a smart watch 10_2c, or the like, and vehicle electronic devices 10_3 including display modules such as a center information display (CID) which may be disposed on a instrument panel, a center fascia, and a dashboard of an automobile and a room mirror display, or the like.

Embodiments of the present disclosure may be applied to various display devices, for example, such as display devices for vehicles, ships and aircraft, portable communication devices, display devices for exhibition or information transmission, medical display devices, and the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An inspection method comprising:
generating a virtual image of a cell based on a design drawing of the cell;
defining a reference coordinate to be inspected in the virtual image of the cell;
defining an interference area in which a capture area of a capture part and a frame overlap each other, wherein the capture part captures the cell, and the frame supports the cell;
identifying an interference coordinate overlapping the interference area in a plan view among the reference coordinate; and
setting an alternative coordinate which is adjacent to the interference coordinate in the cell, has a laminated structure identical to a laminated structure of the interference coordinate, and is spaced apart from the interference area in the plan view.

2. The inspection method of claim 1, wherein in the defining the reference coordinate, the reference coordinate corresponds to one of a line width of a metal line and a position of a hole included in the cell.

3. The inspection method of claim 1, wherein the defining the interference area comprises:
obtaining a plurality of frame coordinates corresponding to the frame; and
serializing the plurality of frame coordinates.

4. The inspection method of claim 1, wherein in the setting the alternative coordinate, a separation distance between the interference coordinate and the alternative coordinate is within about 2 mm.

5. The inspection method of claim 1, further comprising:
comparing a planar shape of the cell at a measurement coordinate, which is a coordinate spaced apart from the interference area among the reference coordinate, and the alternative coordinate with the virtual image of the cell at the measurement coordinate and the alternative coordinate after the setting the alternative coordinate.

6. The inspection method of claim 5, wherein the comparing the planar shape of the cell with the virtual image of the cell comprises checking whether a matching degree between a pattern of the planar shape of the cell and a pattern of the virtual image of the cell is greater than a threshold value.

7. The inspection method of claim 6, wherein the threshold value is greater than or equal to about 0.85.

8. The inspection method of claim 6, further comprising:
measuring at the measurement coordinate and the alternative coordinate of the cell when the matching degree of the pattern is greater than the threshold value.

9. The inspection method of claim 6, further comprising:
redesigning a process for the cell when the matching degree of the pattern is less than or equal to the threshold value.

10. The inspection method of claim 9, wherein the redesigning the process for the cell is performed within about 7 days.

11. The inspection method of claim 10, wherein the generating the virtual image of the cell to the redesigning the process for the cell are performed within about 40 days.

12. The inspection method of claim 9, wherein the process for the cell comprises one of an etching process and a cleaning process.

13. An inspection apparatus comprising:
a virtual image generator which generates a virtual image of a cell based on a design drawing of the cell, wherein the cell is loaded on a frame;
a reference coordinate determination part which defines a reference coordinate to be inspected in the virtual image of the cell;
a cell capture part which captures the cell disposed on the frame and defines an interference area overlapping the frame; and
a measurement part which measures an image of the cell captured by the cell capture part.

14. The inspection apparatus of claim 13, wherein the reference coordinate determination part defines an alternative coordinate adjacent to an interference coordinate which overlaps the interference area defined by the cell capture part in a plan view.

15. The inspection apparatus of claim 14, wherein a separation distance between the interference coordinate and the alternative coordinate is within about 2 mm.

16. The inspection apparatus of claim 13, wherein the frame has a mesh shape in a plan view.

17. The inspection apparatus of claim 13,
wherein the frame comprises a first frame and a second frame,
wherein the first frame defines a first interference area, and the second frame defines a second interference area, and
wherein the interference area is an area where the first interference area and the second interference area overlap each other.

18. The inspection apparatus of claim 13, wherein the reference coordinate corresponds to one of a metal and a hole included in the cell.

19. The inspection apparatus of claim 13, wherein the measurement part measures one of a line width of a metal line and a position of a hole defined by the reference coordinate.

20. An electronic device comprising:
a display device; and
a processor which drives the display device,
wherein the display device is manufactured by an inspection method, and
the inspection method comprises:
generating a virtual image of a cell based on a design drawing of the cell;
defining a reference coordinate to be inspected in the virtual image of the cell;
defining an interference area in which a capture area of a capture part and a frame overlap each other, wherein the capture part captures the cell, and the frame supports the cell;
identifying an interference coordinate overlapping the interference area in a plan view among the reference coordinate; and
setting an alternative coordinate which is adjacent to the interference coordinate in the cell, has a laminated structure identical to a laminated structure of the interference coordinate, and is spaced apart from the interference area in the plan view.
